(19) United States
(12) Patent Application Publication
(10) Pub. No.: US 2026/0226775 A1
(43) Pub. Date: Aug. 6, 2026

(54) LATCH WITH DOUBLE PULL FOR CLOSURE PANEL

(71) Applicant: Magna Closures Inc., Newmarket (CA)

(72) Inventor: Jan HOLBEIN, Newmarket (CA)

(21) Appl. No.: 19/531,372

(22) Filed: Feb. 5, 2026

Related U.S. Application Data
(60) Provisional application No. 63/754,904, filed on Feb. 6, 2025.

(51) Int. Cl. E05B 85/26; E05B 83/24

(52) U.S. Cl. CPC E05B 85/26; E05B 83/243

(57) ABSTRACT

A latch operated by double actuation of a pawl. A ratchet is movable between a primary closed position, a secondary closed position and an open position and biased towards the open position for facilitating travel of a striker in a fishmouth of the latch toward the secondary closed position; the pawl movable between a primary locking position, a secondary locking position and an unlocked position and biased towards the ratchet, the pawl having a pawl locking surface for engaging a primary locking surface on the ratchet for holding the ratchet in the primary closed position and for engaging a secondary locking surface on the ratchet for holding the ratchet in the secondary closed position; a locking lever biased towards an actuated position and having an undercut contour for engaging the pawl to coordinate movement of the pawl during the first actuation and second actuation of the double actuation.

### CROSS-REFERENCE TO RELATED APPLICATIONS

This application claims priority to United States Provisional Patent Application No. 63/754,904, entitled “LATCH WITH DOUBLE PULL FOR CLOSURE PANEL”, filed on February 6, 2025, the entire contents of which is incorporated herein by reference for all purposes.

### FIELD

The present disclosure relates to latches for closure panels and more particularly to vehicle hood latches.

### BACKGROUND

Latches for vehicle hoods and the like are typically actuated in two stages. During a first stage a handle is actuated inside the vehicle which moves the latch from a primary closed position to secondary closed position. To release the latch completely the vehicle occupant typically must exit the vehicle and actuate a lever that is under the hood. This may be inconvenient in some situations.

The current state of the art for hood latch involves two operations to open gain access to the hood, one operation from inside the vehicle followed by an additional hood actuation at the front of the vehicle to complete the release of the latch. Desired is a mechanism to provide for a multiple stage release from inside of the vehicle.

### SUMMARY

In an aspect, a latch for operation using a double actuation of a pawl, the latch comprising: a ratchet movable between a primary closed position, a secondary closed position and an open position, wherein the ratchet is biased towards the open position for facilitating travel of a striker in a fishmouth of the latch to the secondary closed position; the pawl movable between a primary locking position, a secondary locking position and an unlocked position, wherein the pawl is biased towards contact with the ratchet, the pawl having a pawl locking surface for engaging a primary locking surface on the ratchet for holding the ratchet in the primary closed position and the pawl has the pawl locking surface for engaging a secondary locking surface on the ratchet for holding the ratchet in the secondary closed position; a locking lever biased towards an actuated position, the locking lever having a undercut contour for engaging with the pawl in order to coordinate movement of the pawl during a first actuation and a second actuation of the double actuation.

In another aspect, a method for operation of a latch using a double actuation of a pawl, the method including moving a pawl of the latch using a first actuation of the double actuation in order to cause a ratchet to move between a primary closed position and a secondary closed position, wherein the ratchet is biased towards the secondary closed position for facilitating travel of a striker in a fishmouth of the latch to the secondary closed position, engaging a locking lever of the latch with the pawl using an undercut contour positioned on the locking lever in order to restrict movement of the pawl as a result of the first actuation, and moving the pawl using a second actuation in order to cause the ratchet to move from the secondary closed position towards an open position, such that the pawl is unhindered by the locking lever and the locking lever is also uninhibited from stopping action of the pawl and thus the locking lever continues to rotate towards an actuated position.

In another aspect, a latch for operation using a double actuation of a pawl, the latch comprising a ratchet movable between a primary closed position, a secondary closed position and an open position, wherein the ratchet is biased towards the open position for facilitating travel of a striker in a fishmouth of the latch to the secondary closed position, the pawl movable between a primary locking position, a secondary locking position and an unlocked position, wherein the pawl is biased towards contact with the ratchet, the pawl having a pawl locking surface for engaging a primary locking surface on the ratchet for holding the ratchet in the primary closed position and the pawl has the pawl locking surface for engaging a secondary locking surface on the ratchet for holding the ratchet in the secondary closed position, and a blocking arrangement for engaging with the pawl in order to coordinate movement of the pawl during a first actuation and a second actuation of the double actuation. In a related aspect, the blocking arrangement comprises a locking lever mounted about a pivot to a housing of the latch, the locking lever biased towards an actuated position, the locking lever having an undercut contour for engaging with the pawl in order to coordinate movement of the pawl during a first actuation and a second actuation of the double actuation. In a related aspect, after the first actuation travel of the pawl is restricted by the undercut contour of the locking lever when it comes into contact with a cooperating stop positioned on the pawl. In a related aspect, the undercut contour of the locking lever acts as a hard stop for the pawl and thus inhibits further rotation of the pawl as a result of the first actuation, in order to limit the rotation of the pawl prior to implementation of the second actuation. In a related aspect, the locking lever is inhibited from rotation by the interaction between the undercut contour and the cooperating stop as a result of the first actuation. In a related aspect, once the first actuation is completed the bias rotates the pawl towards the ratchet to maintain the contact at the secondary locking surface while simultaneously causing a loss of contact between the undercut contour and the cooperating stop in order to facilitate rotation of the locking lever from a home position and towards the actuated position. In a related aspect, when the ratchet is in the secondary closed position, the locking lever continues to rotate and is stopped by interaction between the undercut contour and a secondary stop of the pawl. In a related aspect, the ratchet is fully released from the pawl and travels towards the open position, such that the pawl is unhindered by the locking lever and the locking lever is also uninhibited from stopping action of the pawl and thus the locking lever continues to rotate towards the actuated position. In a related aspect, a stop of the locking lever is configured for interaction with a ratchet control contour, such that during said interaction a secondary stop of the pawl makes contact with the undercut contour in order to inhibit the pawl from returning to its home position under influence of said bias. In a related aspect, a stop of the locking lever is configured for interaction with a ratchet control contour, such that during said interaction a secondary stop of the pawl makes contact with the undercut contour in order to inhibit the pawl from returning to its home position under influence of said bias.

In another aspect, a latch for operation using a double actuation of a pawl, the latch comprising a ratchet movable between a primary closed position, a secondary closed position and an open position, wherein the ratchet is biased towards the open position for facilitating travel of a striker in a fishmouth of the latch to the secondary closed position, the pawl movable between a primary locking position, a secondary locking position and an unlocked position, wherein the pawl is biased towards contact with the ratchet, the pawl having a pawl locking surface for engaging a primary locking surface on the ratchet for holding the ratchet in the primary closed position and the pawl has the pawl locking surface for engaging a secondary locking surface on the ratchet for holding the ratchet in the secondary closed position, and a blocking arrangement for engaging with the pawl in order to coordinate movement of the pawl during a first actuation and a second actuation of the double actuation. In a related aspect, the blocking arrangement coordinates movement of the pawl based on movement of the ratchet interacting with the blocking arrangement.

### BRIEF DESCRIPTION OF THE DRAWINGS

The foregoing and other aspects will now be described by way of example only with reference to the attached drawings, in which:

FIG. 1 is a plan view of a latch with a ratchet in a primary closed position;

FIG. 2 is a plan view of the latch shown in FIG. 1, with the ratchet in an open position;

FIG. 3a is a plan view of the latch shown in FIG. 1, showing movement of a pawl during a first actuation;

FIG. 3b shows a portion of FIG. 3a in an enlarged view;

FIG. 4a is a plan view of the latch shown in FIG. 1, showing release of the pawl from the first actuation, with the ratchet in a secondary closed position;

FIG. 4b shows a portion of FIG. 4a in an enlarged view;

FIG. 5a is a plan view of the latch shown in FIG. 1, showing the result of latch component travel during the first actuation of the pawl;

FIG. 5b shows a portion of FIG. 5a in an enlarged view;

FIG. 6a is a plan view of the latch shown in FIG. 1, showing movement of a locking lever thereof resulting from the first actuation;

FIG. 6b shows a portion of FIG. 6a in an enlarged view;

FIG. 7 is a plan view of the latch shown in FIG. 1, showing movement of the pawl by a second actuation;

FIG. 8a is a plan view of the latch shown in FIG. 1, showing movement of the locking lever resulting from the second actuation;

FIG. 8b shows a portion of FIG. 8a in an enlarged view;

FIG. 9 is a plan view of the latch shown in FIG. 1 showing unimpeded movement of the ratchet to the open position;

FIG. 10a is a plan view of the latch shown in FIG. 1, showing cooperative movement between the pawl and the locking lever associated with movement of the ratchet to the open position; and

FIG. 10b shows a portion of FIG. 10a in an enlarged view.

### DETAILED DESCRIPTION

A vehicle (not shown) has a hood, on which there is a striker 22. The striker 22 is capturable by a latch 10 that is mounted on the body of the vehicle. A cable can operably connect a pawl 14 to an actuation handle or the like in the passenger compartment of the vehicle. Actuation (e.g. first pull and second pull) of the handle causes a ratchet 12 eventually to travel to an open position.

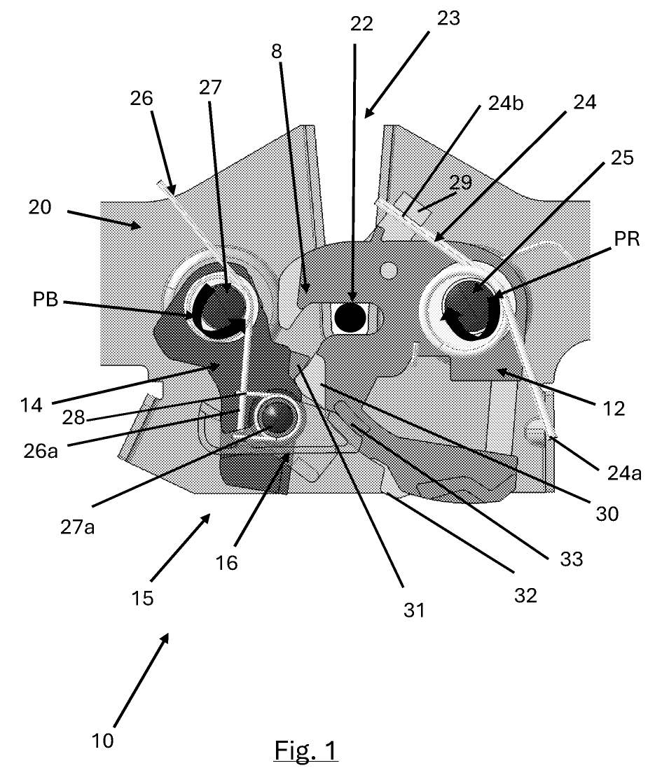

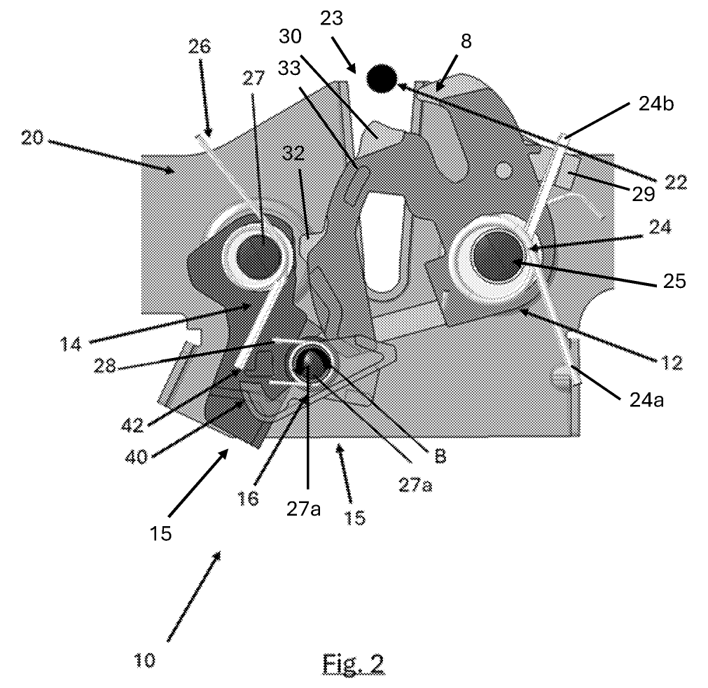

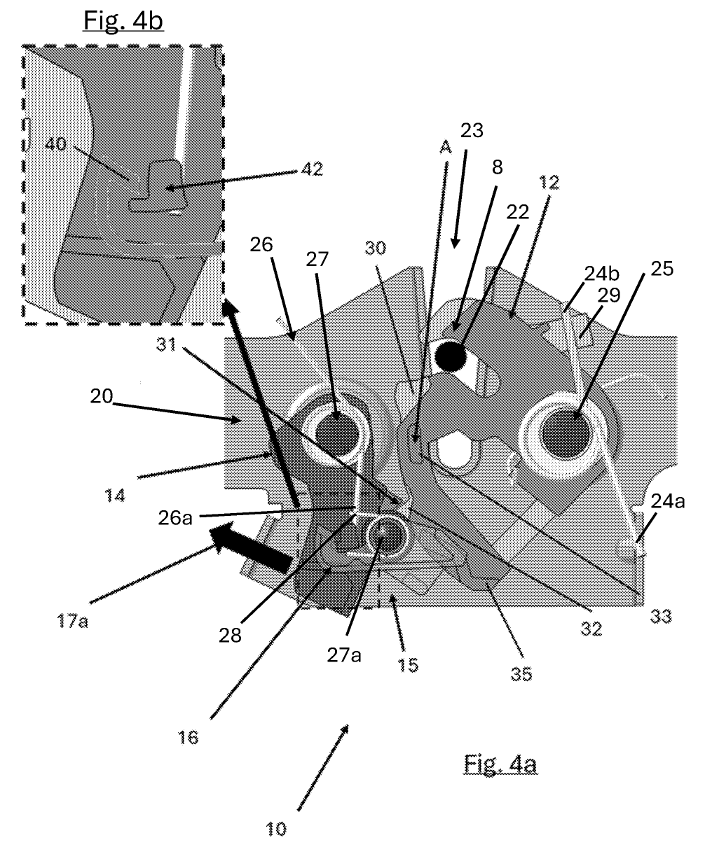

Referring to FIG. 1, the latch 10 includes the ratchet 12, the pawl 14, a blocking arrangement 15 illustratively shown as having a locking lever 16, and a housing 20 (part of which is omitted for clarity). As shown in FIG. 1, the ratchet 12 is pivotably connected to the housing 20, illustrated as having a metal frame plate, and is movable between a primary closed position shown in FIG. 1, a secondary closed position shown in FIG. 4a (a result of a first pull), and an open position shown in FIG. 2 (a result of a second pull). The blocking arrangement 15 is for engaging with the pawl 14 in order to coordinate movement of the pawl 14 during a first actuation and a second actuation of the double actuation or double pull process to fully release the pawl 14 from the ratchet 12.

The pivotal movement of the ratchet 12 may take place about a pin 25 that is mounted to the housing 20. In the primary and secondary closed positions, the ratchet 12 inhibits the withdrawal of the striker 22 from a fishmouth 23; the striker 22 is mounted on the vehicle hood or other closure panel from the latch 10. When in the primary closed position, the ratchet 12 holds the striker 22 relatively deeper into the fishmouth of the housing 20 than in the secondary closed position. Thus, in the primary closed position the ratchet 12 holds the striker 22 at a first depth in a fishmouth 23 of the housing 20, and in the secondary closed position the ratchet 12 holds the striker 22 at a second depth in a fishmouth 23 of the housing 20.

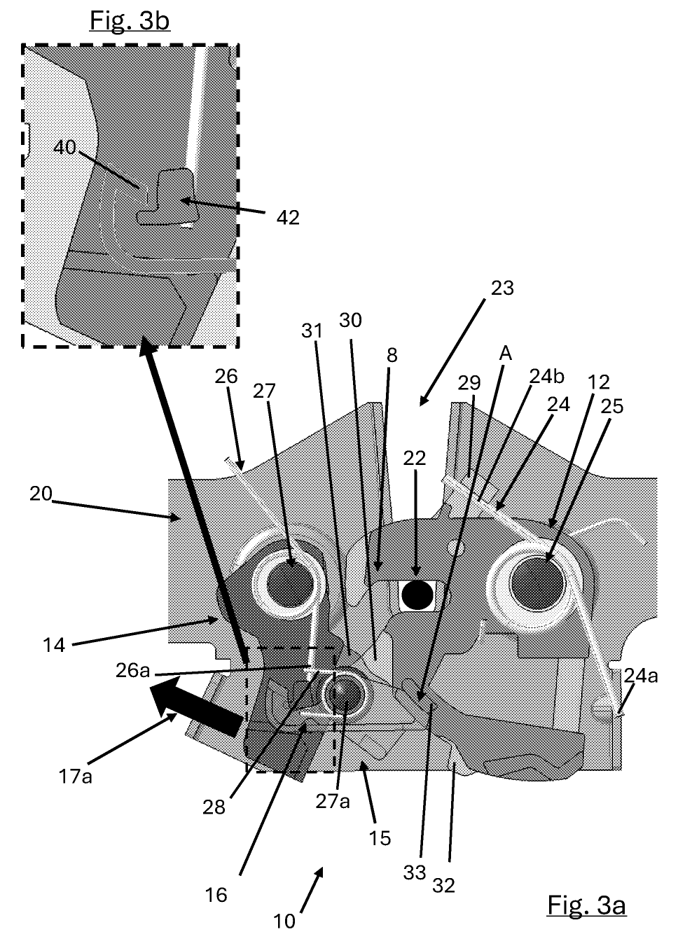

In one example, a body of the ratchet 12 can have a hook portion 8 (see FIG. 1a) for inhibiting release of the striker 22 from the fishmouth 23 when the pawl 14 and ratchet 12 are in the secondary closed position, which occurs as a result of operation of the release mechanism (see FIG. 3a, e.g. release mechanism can include a release lever of the pawl 14, not shown, connected to the cable mentioned above) misaligning the pawl 14 from engagement with a primary locking surface 30 (see FIG. 3a) on the ratchet 12 and aligning for subsequent engagement of the pawl 14 with a secondary locking surface 32 on the ratchet 12 (see FIG. 4a). Alternatively, the hook portion 8 can be separate from the body of the ratchet 12. Secondary closed position of the ratchet 12 is defined as the position of the striker 22 in the fishmouth 23 that is distanced away from the primary closed position while at the same time having the striker 22 being restricted by the hook portion 8 from leaving the fishmouth 23 (i.e. placing the latch 10 in an open state – see FIG. 2).

The ratchet 12 is biased towards the open position by a ratchet biasing member 24, shown using arrow PR. The ratchet biasing member 24 may be, for example, a torsion spring. The torsion spring may extend around the pin 25 and may have a first end 24a anchored (e.g. to the housing 20) and a second end 24b that acts against an engagement member 29 on the ratchet 12.

The pawl 14 is pivotably connected to the housing 20 and is movable between a primary locking position (FIG. 1), a secondary locking position (FIG. 4a) and an unlocked position (FIG. 2). The pivotal movement of the pawl 14 may be about a pin 27. In the primary locking position (FIG. 1) a pawl locking surface 31 on the pawl 14 engages the primary locking surface 30 on the ratchet 12 and holds the ratchet 12 in the primary closed position. In the secondary locking position (FIG. 4a), the pawl locking surface 31 can engage the secondary locking surface 32 on the ratchet 12 to hold the ratchet 12 in the secondary closed position. In the unlocked position (FIG. 2) the pawl 14 provides for the ratchet 12 to move to the open position as unhindered by the pawl 14. The pawl 14 is biased towards the primary locking position by a pawl biasing member 26, which biases the pawl 14 towards the ratchet 12 as shown by arrow PB. The pawl biasing member 26 may be, for example, a torsion spring. The torsion spring may extend around the pin 27 and have a first end anchored on the housing 20, and a second end 26a that engages with a lug on the pawl 14 (not shown). Locking lever 16, as a pivotable lever, pivots about pivot 27a which is illustratively mounted to the latch housing 20, such as to another frame plate, or housing cover or other metal or plastic housing portion, via a rivet or fastener for example. Thus, the locking lever 16 is pivotally mounted to the latch housing 20.

As one example of the locking lever 16, as a pivotal lever, it is pivotably connected to the housing 20 and is movable between a home position, also referred to as a first position, shown in FIG. 1, and an actuated position shown in FIG. 2. The pivotal movement of the locking lever 16 (i.e. movement of the locking lever 16 from the home position to the actuated position) facilitates movement of the pawl 14 from the secondary locking position to the unlocked position, as described further below. The locking lever 16 can be biased towards the actuated position, also referred to as a second position, by a biasing member shown at 28, in a direction indicated by arrow B. The biasing member 28 may be, for example, a torsion spring that has a first prong connected to the housing 20, and another prong connected to the locking lever 16.

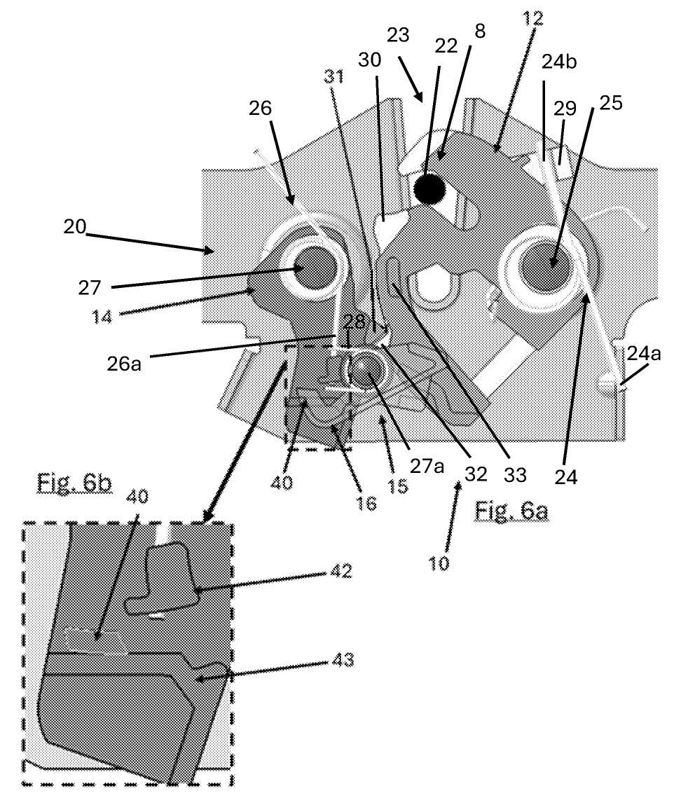

Referring to FIGS. 3a and 3b, after the first pull/actuation of the release mechanism (e.g. including the cable described above), actuation of the pawl 14 occurs, as indicated by arrow 17a. Generally, the blocking arrangement 15, and for example the locking lever 16, is configured to engage the pawl 14 during a first actuation of the pawl 14 to limit the travel (e.g. at a first maximum angular position) of the pawl 14 away from the ratchet 12, and more specifically past a position away from the ratchet 12 where the pawl locking surface 31 is out of alignment with the secondary locking surface 32, but rather at the limited range of travel that the pawl locking surface 31 is aligned with the secondary locking surface 32. The travel (i.e. pivot) of the pawl 14 away from the ratchet 12 is restricted by an undercut contour 40 on the locking lever 16 when it comes into contact with a stop 42 mounted in the pawl 14. FIG. 3b shows detail of the stop 42 and the undercut contour 40 to carry the locking lever 16. As shown in FIG. 3a, the locking lever 16 is held down (i.e. in the home position) by the ratchet 12 after the first pull by a contact region A (e.g. contour 33) on the ratchet 12. In other words, after the first pull, the pawl 14 releases the ratchet 12 and makes contact with the locking lever 16 as shown/described. Movement of the pawl 14 disengages the pawl locking surface 31 on the pawl 14 from the primary locking surface 30 on the ratchet 12, releasing the ratchet from the primary closed position (“primary release”). The blocking arrangement 15 shown illustratively as a locking lever 16 having a first position (e.g. FIG. 1) whereat a blocking surface (e.g. undercut contour 40) of the locking lever 16 is aligned with a stop (e.g. stop 42) provided on the pawl 14 when the pawl 14 is in the primary locking position (e.g. FIG. 1), and having a second position (e.g. FIG. 6A) whereat the blocking surface (e.g. undercut contour 40) of the locking lever 16 is misaligned with the stop 42 provided on the pawl 14 when the pawl 14 is in the secondary locking position (FIG. 6a). The blocking arrangement 15 shown illustratively as a locking lever 16 is shown in FIG. 1 to be interacting with the ratchet 12, and in particular with a contour 33 of the ratchet such that when the ratchet 12 is in the primary locking position as shown in FIGS. 1 and 3A, the interaction of the locking lever 16 with the contour 33 can control the blocking state of the blocking arrangement 15 shown illustratively as a locking lever 16. In particular, the interaction of the locking lever 16 with the contour 33 resists the action of the biasing member 28 to prevent the locking lever 16 from moving away from the first position. Thus, the locking lever 16 is adapted to interact with the ratchet 12 to control the movement of the locking lever 16 between the first position and the second position.

Referring to FIGS. 4a and 4b, the ratchet 12 goes into its secondary closed position and is being blocked by the pawl 14. Further, the pawl 14 blocks the ratchet 12 by engagement of the pawl locking surface 31 with the secondary locking surface 32, the undercut contour 40 comes into contact with the stop 42 (e.g. the undercut contour 40 is also used to carry the locking lever 16 as further described), and thus the locking lever 16 has now lost contact with the ratchet 12 but is blocked by the pawl 14. Specifically, the locking lever 16 is blocked from rotation (e.g. travel to the actuated position) by the interaction between the undercut contour 40 and the stop 42. As such, the undercut contour 40 of the locking lever 16 acts as a hard stop for the pawl 14 during the first release pull, and the ratchet 12 cannot therefore be fully released upon only a single actuation (denoted by arrow 17a). Simultaneously, the contact interaction between the undercut contour 40 and the stop 42 during operation of the first pull stops the locking lever 16 from rotating about its pivot 27a.

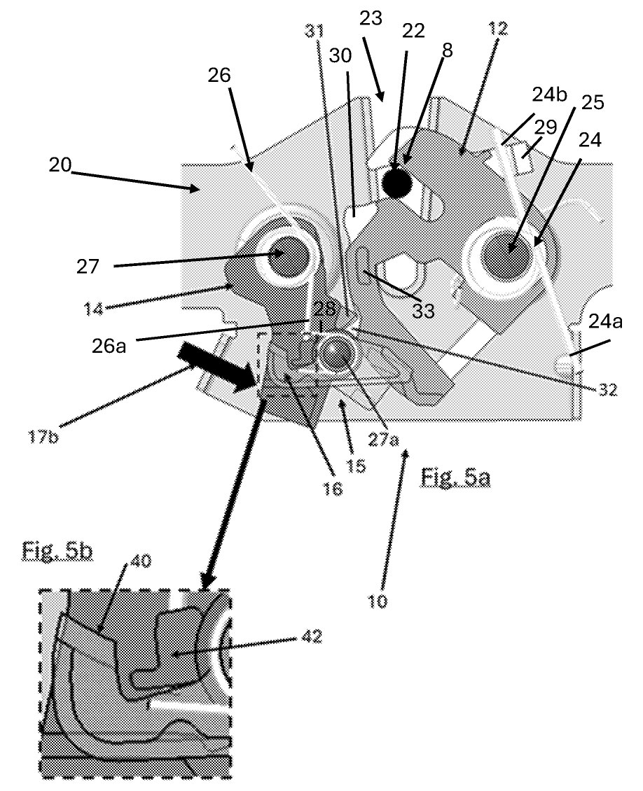

Referring to FIGS. 5a and 5b, once the first pull is completed (e.g. the handle is released by the occupant of the vehicle 11), the biasing element 26 rotates the pawl 14 towards the ratchet 12 to maintain the contact at secondary locking surface 32. This rotation is denoted by arrow 17b. This simultaneously provides for a release (e.g. loss of contact) between the undercut contour 40 and the stop 42. The locking lever 16 is released and can rotate counterclockwise. In this manner, the locking lever 16 gets released from the home position and travels towards the actuated position (see FIGS. 6a, 6b) under influence of the biasing member 28.

Referring to FIGS. 6a and 6b, in the intermediate latching position, the locking lever 16 continues to rotate counterclockwise and is stopped by interaction between the undercut contour 40 and the pawl’s contour 43, which acts as a secondary stop 43 of the pawl 14. The ratchet 12 can be held in balance by the weight of the hood and the driving energy storage, or it can strike the pawl 14 or an external mechanical component. The blocking arrangement 15, and as illustratively shown the locking lever 16, is configured in this position to not engage with the pawl 14 during a subsequent second actuation of the pawl 14, as will be described herein below, to allow the pawl 14 to move further away from the ratchet 12, and further away from the first limited position of travel than during the first actuation so that the pawl locking surface 31 becomes misaligned with the secondary locking surface 32 to allow the ratchet 12 to move to the open position. The ratchet 12 continues to be blocked by the pawl 14 by engagement of the pawl locking surface 31 with the secondary locking surface 32 on the ratchet 12.

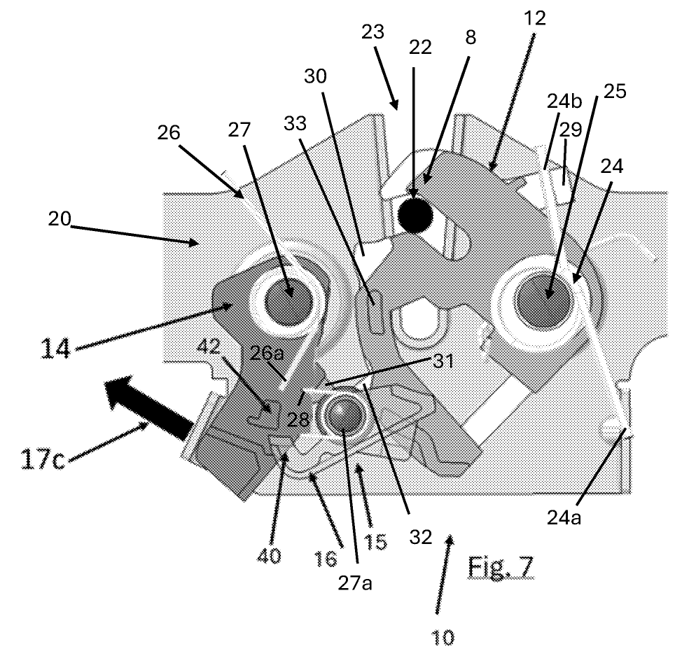

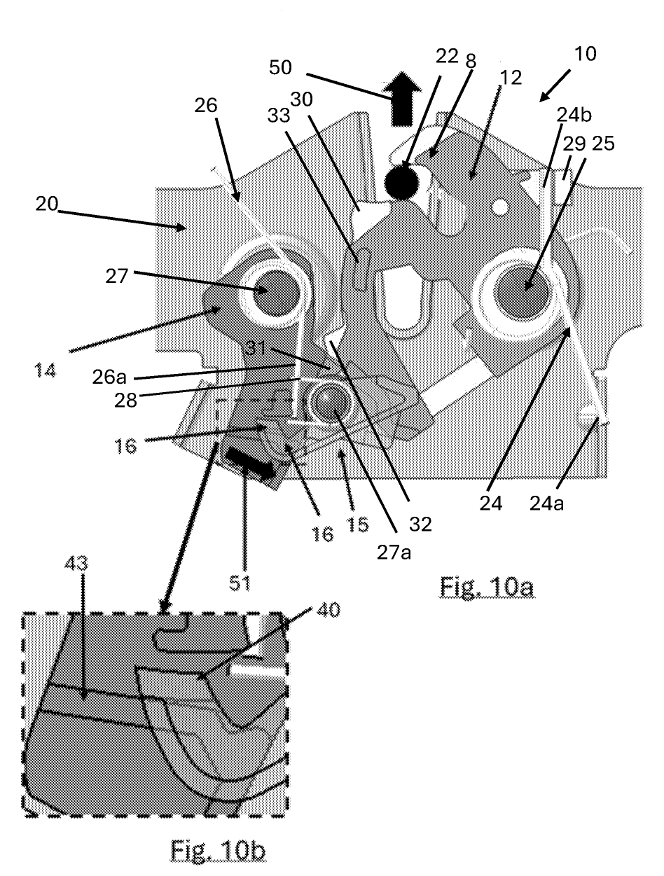

Referring to FIG. 7, once the pawl 14 is actuated a second time (i.e. second pull of the handle, denoted by arrow 17c), the pawl locking surface 31 loses contact with the secondary locking surface 32 and the ratchet 12 is fully released such that the ratchet 12 can travel to the fully open position (see FIG. 2). It should be noted that during the second pull, the pawl 14 is not blocked by the locking lever 16 and thus more travel of the pawl 14 can be experienced as a result of the second pull. Further, the locking lever 16 is released from the stopping action of the pawl 14 and thus can continue to rotate towards the actuated position (see FIG. 10). The blocking arrangement 15, and as illustratively shown the locking lever 16, is configured in this position to not engage with the pawl 14 during the subsequent second actuation of the pawl 14, to allow the pawl 14 to move further away from the ratchet 12, and from the first limited position of travel, than during the first actuation so that the pawl locking surface 31 becomes misaligned with the secondary locking surface 32 to allow the ratchet 12 to move to the open position.

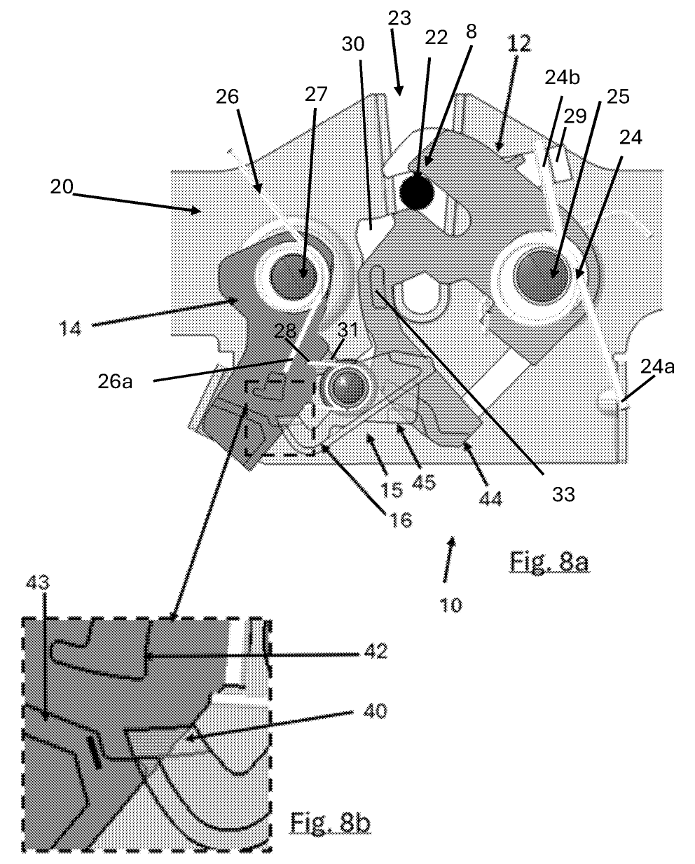

Referring to FIGS. 8a and 8b, the locking lever 16 can rotate counterclockwise and is shown rotating further such that it contacts (by stop 45) the ratchet 12 at ratchet control contour 44, illustrating another interaction of the ratchet 12 with the blocking arrangement 15, and as illustratively shown the locking lever 16 to control the positioning of the locking lever 16. Thus, the ratchet 12 comprises at least one profile (e.g. ratchet control contour 44) for controlling angular rotation of the locking lever 16. The locking lever 16 can thus be held in a third position as shown in FIG. 8a and FIG. 8b. In this case, the ratchet 12 is fully released and the end stop contour 43 of pawl 14 makes contact with the undercut contour 40 of the locking lever 16, such that this contact blocks or inhibits the pawl 14 from moving from the unlocked position towards the ratchet 12 and returning to its home position under influence of the biasing element 26.

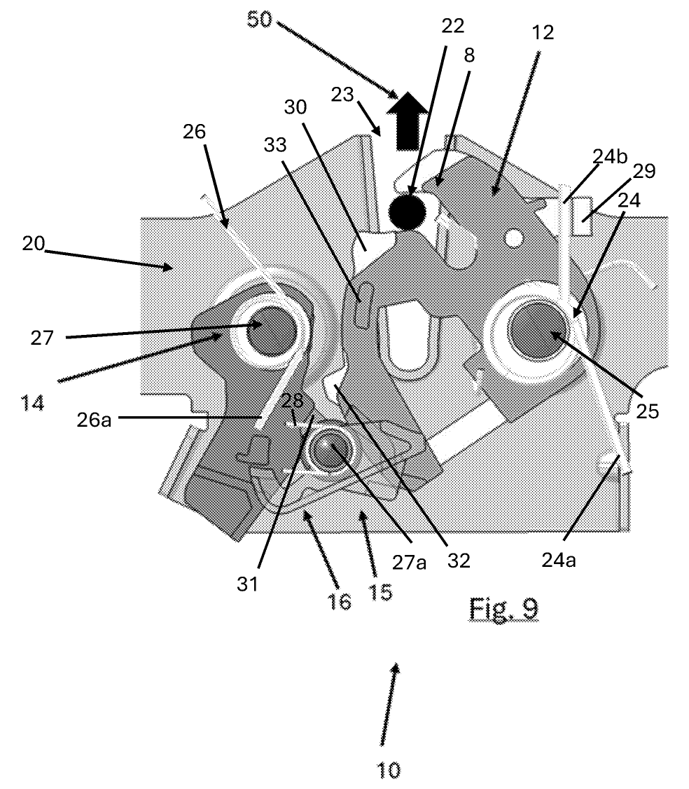

Referring to FIG. 9, opening of the hood, denoted by arrow 50, can occur by hand. The energy storage (e.g. spring 24) can be strong enough to hold the hood in balance but not strong enough to lift the hood. The stop 45 follows a profile of the ratchet control contour 44 as the ratchet 12 is rotated because of opening of the hood (e.g. being driven by movement of the striker 22 in the fishmouth 23 (see FIGS. 2,4), illustrating another interaction between the ratchet 12 and the blocking arrangement 15, and as illustratively shown the locking lever 16. In this manner, the ratchet 12 disengages the locking lever 16 from the pawl 14 (i.e. end stop contour 43 no longer is engaged and thus blocked by the undercut contour 40) As a result, as shown in FIGS. 10a and 10b, the pawl 14 is no longer blocked by the locking lever 16 and thus the pawl returns (arrow 51) to the pawl home position under influence of the biasing element 26 (see FIG. 1). Further, the locking lever 16 is being held (by the undercut contour 40) in the actuated position by end stop contour 43 of the pawl 14. Unimpeded, the ratchet 12 is moved to the open position (see FIG. 2).

A closing sequence of the latch 10 will now be described. First, the striker 22 movement rotates the ratchet 12 against the biasing element 24 from the open position towards the secondary closed position. Then, the ratchet 12 reaches the secondary closed position with the latch 10 components put in their positions and contact/stop placements as discussed above. Next, the ratchet 12 moves past the secondary closed position (before reaching the primary closed position) with the latch 10 components put in their positions and contact/stop placements as discussed above. Finally, the ratchet 12 moves into the primary closed position with the latch 10 components put in their positions and contact/stop placements as discussed above.

A method for operation of the latch 10 using a double actuation of a pawl 14 will now be described. The method comprises a first step moving the pawl 14 of the latch 10 using a first actuation of the double actuation in order to cause the ratchet 12 to move between a primary closed position and a secondary closed position, wherein the ratchet 12 is biased towards the secondary closed position for facilitating travel of the striker 22 in the fishmouth 23 of the latch 10 to the secondary closed position. The method comprises a second step of engaging the locking lever 16 with the pawl 14 using the undercut contour 40 positioned on the locking lever 16 to restrict movement of the pawl 14 as a result of the first actuation. The method comprises a third step of moving the pawl 14 using a second actuation in order to cause the ratchet 12 to move from the secondary closed position towards the open position, such that the pawl 14 is unhindered by the locking lever 16 and the locking lever 16 is also uninhibited from stopping action of the pawl 14 and thus at a fourth step the locking lever 16 continues to rotate towards an actuated position.

While the above description constitutes a plurality of embodiments, it will be appreciated that the present disclosure is susceptible to further modification and change without departing from the fair meaning of the accompanying claims.

1. A latch (10) for operation using a double actuation of a pawl (14), the latch comprising:
a ratchet (12) movable between a primary closed position, a secondary closed position and an open position, wherein the ratchet is biased towards the open position for facilitating travel of a striker (22) in a fishmouth (23) of the latch to the secondary closed position;
the pawl movable between a primary locking position, a secondary locking position and an unlocked position, wherein the pawl is biased towards contact with the ratchet, the pawl having a pawl locking surface (31) for engaging a primary locking surface (30) on the ratchet for holding the ratchet in the primary closed position and the pawl has the pawl locking surface for engaging a secondary locking surface (32) on the ratchet for holding the ratchet in the secondary closed position; and
a blocking arrangement (15) for engaging with the pawl in order to coordinate movement of the pawl during a first actuation and a second actuation of the double actuation.

2. The latch of claim 1, wherein the blocking arrangement is configured to engage the pawl during a first actuation to limit the travel of the pawl away from the ratchet such that the pawl locking surface (31) is aligned with the secondary locking surface, and is configured to not engage with the pawl during the second actuation to allow the pawl to move further away from the ratchet than during the first actuation so that the pawl locking surface (31) is misaligned with the secondary locking surface (32) to allow the ratchet to move to the open position.

3. The latch of claim 2, wherein the blocking arrangement comprises a locking lever (16) having a first position whereat a blocking surface (40) of the locking lever is aligned with a stop (42) provided on the pawl when the pawl is in the primary locking position, and having a second position whereat the blocking surface of the locking lever is misaligned with the stop provided on the pawl when the pawl is in the secondary locking position.

4. The latch of claim 3, wherein the locking lever is pivotally mounted to a housing of the latch.

5. The latch of claim 4, wherein the locking lever is biased towards the second position by a spring.

6. The latch of claim 4, wherein the locking lever is adapted to interact with the ratchet to control the movement of the lever between the first position and the second position.

7. The latch of claim 6 wherein the ratchet comprises at least one profile for controlling angular rotation of the pivotable lever.

8. The latch of claim 4, wherein the locking lever has a third position to inhibit the pawl from moving from the unlocked position towards the ratchet.

9. The latch of claim 1, wherein the blocking arrangement comprises a locking lever (16) mounted about a pivot to a housing of the latch, the locking lever biased towards an actuated position, the locking lever having an undercut contour (40) for engaging with the pawl in order to coordinate movement of the pawl during a first actuation and a second actuation of the double actuation.

10. The latch of claim 9 further comprising the undercut contour positioned on the locking lever and a cooperating stop (42) positioned on the pawl, such that
after the first actuation travel of the pawl is restricted by the undercut contour when it comes into contact with the cooperating stop.

11. The latch of claim 10, wherein the undercut contour of the locking lever acts as a hard stop for the pawl and thus inhibits further rotation of the pawl as a result of the first actuation, in order to limit the rotation of the pawl prior to implementation of the second actuation.

12. The latch of claim 11, wherein the locking lever is inhibited from rotation by the interaction between the undercut contour and the cooperating stop as a result of the first actuation.

13. The latch of claim 10, wherein once the first actuation is completed the bias rotates the pawl towards the ratchet to maintain the contact at the secondary locking surface while simultaneously causing a loss of contact between the undercut contour and the cooperating stop in order to facilitate rotation of the locking lever from a home position and towards the actuated position.

14. The latch of claim 10, wherein in the secondary closed position, the locking lever continues to rotate and is stopped by interaction between the undercut contour and a secondary stop (43) of the pawl.

15. The latch of claim 13, wherein as a result of the second actuation, the ratchet is fully released from the pawl and travels towards the open position, such that the pawl is unhindered by the locking lever and the locking lever is also uninhibited from stopping action of the pawl and thus the locking lever continues to rotate towards the actuated position.

16. The latch of claim 10 further comprising a stop (45) of the locking lever configured for interaction with a ratchet control contour (44), such that during said interaction a secondary stop (43) of the pawl makes contact with the undercut contour in order to inhibit the pawl from returning to its home position under influence of said bias.

17. The latch of claim 15 further comprising a stop (45) of the locking lever configured for interaction with a ratchet control contour (44), such that during said interaction a secondary stop (43) of the pawl makes contact with the undercut contour in order to inhibit the pawl from returning to its home position under influence of said bias.

18. A latch (10) for operation using a double actuation of a pawl (14), the latch comprising:
a ratchet (12) movable between a primary closed position, a secondary closed position and an open position, wherein the ratchet is biased towards the open position for facilitating travel of a striker (22) in a fishmouth (23) of the latch to the secondary closed position;
the pawl movable between a primary locking position, a secondary locking position and an unlocked position, wherein the pawl is biased towards contact with the ratchet, the pawl having a pawl locking surface (31) for engaging a primary locking surface (30) on the ratchet for holding the ratchet in the primary closed position and the pawl has the pawl locking surface for engaging a secondary locking surface (32) on the ratchet for holding the ratchet in the secondary closed position; and
a blocking arrangement for engaging with the pawl and with the ratchet in order to allow or prevent movement of the pawl during a first actuation and a second actuation of the double actuation is, wherein the blocking arrangement coordinates movement of the pawl based on movement of the ratchet interacting with the blocking arrangement.

19. The latch of claim 18, wherein the blocking arrangement comprises a biased lever.

20. A method for operation of a latch (10) using a double actuation of a pawl (14), the method comprising:
moving a pawl of the latch using a first actuation of the double actuation in order to cause a ratchet (12) to move between a primary closed position and a secondary closed position, wherein the ratchet is biased towards the secondary closed position for facilitating travel of a striker (22) in a fishmouth (23) of the latch to the secondary closed position;
engaging a locking lever (16) of the latch with the pawl using an undercut contour (40) positioned on the locking lever in order to restrict movement of the pawl as a result of the first actuation; and
moving the pawl using a second actuation in order to cause the ratchet to move from the secondary closed position towards an open position, such that the pawl is unhindered by the locking lever and the locking lever is also uninhibited from stopping action of the pawl and thus the locking lever continues to rotate towards an actuated position.
